(19) United States
(12) Patent Application Publication
(10) Pub. No.: US 2009/0320096 A1
(43) Pub. Date: Dec. 24, 2009

(54) MANAGING ACCESS TO A HEALTH-RECORD

(75) Inventors: Sean Nolan, Bellevue, WA (US); Robert May, Issaquah, WA (US); Johnson Apacible, Mercer Island, WA (US); Michael Patrick Gordon, Redmond, WA (US); Tien Suwandy, Sammamish, WA (US); Matthew Wagner, Redmond, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/145,481

(22) Filed: Jun. 24, 2008

(51) Int. Cl. G06F 21/00

(52) U.S. Cl. 726/2

(57) ABSTRACT

A method to regulate access to a health record of an individual includes receiving a request from an application, the request identifying an item in the health record to which access is requested. The method further includes presenting the request to a marshal of the health record via a user interface and receiving a response from the marshal of the health record via the user interface, the response indicating whether access to the item is authorized or withheld. The method further includes granting the application access to the item if the response indicates that access to the item is authorized, and denying access to the item from the application if the response indicates that access to the item is withheld.

### BACKGROUND

There is significant interest today in allowing individuals greater control over their health records, which may include medical and dental records as well as exercise and fitness-related records, among others. Some approaches make health-record data accessible from a central, electronic database. In such approaches, it may be advantageous to carefully regulate access to the database by health-care and other service providers, in order to safeguard the privacy of the individuals to whom the health records belong.

### SUMMARY

A method to regulate access to a health record of an individual is disclosed. The method includes receiving a request from an application, the request identifying an item in the health record to which access is requested. The method further includes presenting the request to a marshal of the health record via a user interface and receiving a response from the marshal of the health record via the user interface, the response indicating whether access to the item is authorized or withheld. The method further includes granting the application access to the item if the response indicates that access to the item is authorized, and denying access to the item from the application if the response indicates that access to the item is withheld.

It should be understood that the summary above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

FIG. 1 shows an example health-record server and an exchange of data, requests, and responses among marshals, applications, and the health-record server, according to one embodiment of the present disclosure.

FIG. 2 shows an example access-authorizations data structure in accordance with the present disclosure.

FIG. 3 shows an example request for health-record access by an application in accordance with the present disclosure.

FIG. 4 shows an example method to regulate access to a health record of an individual in accordance with the present disclosure.

FIG. 5 shows an example method of presenting a request for access to one or more items in a health record in accordance with the present disclosure.

FIG. 6 shows an example method for presenting a sequence of requests to one or more marshals of a health record for access to one or more items in the health record, in accordance with the present disclosure.

FIG. 7 shows an example method to present a request for access to items in one or more health records to a marshal of the one or more health records via a user interface, in accordance with the present disclosure.

FIG. 8 shows an example first presentation of a user interface configured to enable a marshal to select one or more health records to which access may be determined in a second, subsequent presentation of the user interface, in accordance with the present disclosure.

FIG. 9 shows an example second presentation of a user interface, configured to enable a marshal to determine access to one or more items in a health record selected in a first, prior presentation of the user interface, in accordance with the present disclosure.

FIG. 10 shows another instance of the example second presentation of FIG. 9, in accordance with the present disclosure

### DETAILED DESCRIPTION

Systems and methods for regulating health-record access in accordance with the present disclosure are described herein by example.

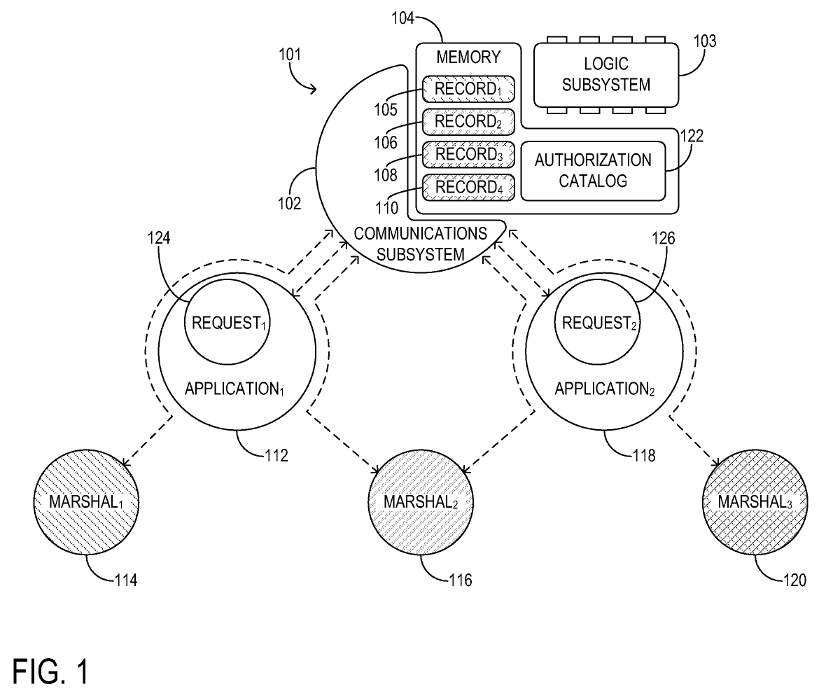

FIG. 1 shows example health-record server 101, which is configured to serve health-record data pertaining to one or more individuals. The health-record server includes communications subsystem 102, logic subsystem 103, and memory 104, operatively coupled to one another. The communications subsystem may include appropriate hardware and software to enable the health-record server to communicate with other devices over one or more networks, which may include the Internet. The logic subsystem may include one or more processors and other hardware to enable the health-record server to execute encoded instructions. The memory may be any device-readable storage medium—optical, magnetic, or semiconductor, as examples—capable of storing the encoded instructions and other data.

The data served by health-record server 101 may be organized into a plurality of different health records, each health record indexed according to the individual to whom the health record pertains. In the illustrated embodiment, the health-record server serves data from four different individuals; these data are organized into first health record 105, second health record 106, third health record 108, and fourth health record 110. For purposes of illustration, only four health records are shown in the drawing, but it should be understood that the health-record server may be configured to serve virtually any number of health records. Likewise, the drawing shows all four health records included in memory 104, implying that they may be stored locally on a storage medium of the health-record server. It should be understood, however, that some or all of the served data may, in other embodiments, be distributed over a network and provided via the health-record server according to known networking protocols.

An individual's health record may include various data; the data may be derived from one or more clinical examinations, informal examinations, and/or queries of the individual and may be stored in a device-readable format. Data within a health record may comprise a plurality of different items, each item including an ensemble of related or associated data to which access may be granted or denied at once. Thus, one item in a health record may be a single data point, e.g. a last-recorded body weight. Another item in the same health record may comprise multiple data points, e.g., a history of cholesterol levels spanning several years. As the present disclosure provides systems and methods for regulating access to health-record data in a granular manner, the term ‘item,’ as used herein, refers to the smallest grain to which access may be granted or denied at once.

Example items in an individual's health record may include the individual's height, body weight, blood pressure, blood glucose, and cholesterol levels, each taken separately. Example items may further include results of other blood or urine analyses, x-rays, sonograms, and other image data. Example items may further include a list of medications prescribed for the individual, clinically advised dietary restrictions, a history of health-care services received, a list of congenital illness or other health-related conditions in the individual's ancestry, whether or not the individual is a smoker, and/or any other health-related data. Finally, example items in an individual's health record may include indications of the individual's exercise, fitness, or athletic activities, discretionary dietary restrictions, and identifying data such as a mailing or email address, birth date, eye color, etc.

FIG. 1 shows first application 112, a computer program configured to provide a health-related service to one or more individuals. In some embodiments, the first application may be executed from a computer, work station, or server of a health-related service provider. In some embodiments, the first application may be a web-based application; it may include or be encoded in an internet web page, for example.

In some embodiments, the first application may be used in a clinical environment to provide a clinical service: example clinical services may include correlating an individual's symptoms and/or blood-test results with conditions characteristic of known pathologies, checking for undesirable pharmacological interactions among medications prescribed for the individual, etc. In other embodiments, the first application may be used to provide a health-related service in a less formal setting—a gym or diet center, for example. Thus, the first application may be configured to analyze data from an individual's health record and, based on the analysis, to recommend one or more diets and/or exercise regimens to assist the individual in his or her fitness goals.

Embodiments consistent with this disclosure may accommodate a plurality of different applications, each providing different or competing health-related services to one or more individuals. Thus, FIG. 1 shows second application 118, defined in the same terms as first application 112, and substantially the same or at least partly different than the first application.

In order to provide a health-related service to an individual, an application may require access to the individual's health record. Thus, health-record server 101 may be configured to grant the application access to one or more items in the individual's health record if such access is requested by the application and authorized by a marshal of the health record. Conversely, the health-record server may be configured to deny access to one or more items in the health record if such access is withheld the application by a marshal of the health record. ‘A marshal of a health record,’ as used herein, refers to a person having a right, legal or otherwise, to grant or deny access to the health record. As such, a marshal of a health record is to be distinguished from an ‘administrator of a health record,’ who may have additional rights beyond that of the marshal. An administrator of a health record may, for example, have the right to authorize an individual to be a marshal of the health record.

FIG. 1 shows first marshal 114, a marshal of first health record 105; second marshal 116, a marshal of second health record 106; and third marshal 120, a marshal of third health record 108 and of fourth health record 110. In one non-limiting example, an individual may be a marshal of his or her own health record. Thus, in the illustrated example, the first health record may be a health record of the first marshal. On the other hand, an individual may be a marshal of another's health record. For example, the second health record may belong to an elderly parent of the second marshal. It is further contemplated that one individual may be a marshal of multiple health records (i.e., different health records belonging to different individuals). Thus, in the illustrated example, the third health record may belong to a minor child of the third marshal, and the fourth health record may belong to the third marshal herself. Further still, it is contemplated that more than one individual may have a legal right to grant or deny access to the same health record, i.e. there may be two or more marshals of the same health record. In embodiments in which two or more different mashals may determine access to the same health record, one or more authorization-reconciling mechanisms may be applied to reconcile conflicting access determinations made by first and second marshals. Thus, in some embodiments, different marshals of the same health record may be ranked in order of their right to modify an access authorization determined by another marshal. As a result, the mere fact that a marshal withholds access to an item from an application may not guarantee that the application will be denied access to that item. Whether or not the application is denied access may, in these embodiments, depend on access determinations made by higher-ranking marshals.

As access to one or more items in an individual's health record may be required by an application and authorized by a marshal of the health record, health-record server 101 may be further configured to mediate a request for access from the application to the marshal and to grant or deny the access based on a response to the request. In FIG. 1, therefore, first application 112 may request access to first health record 105 from first marshal 114 and access to second health record 106 from second marshal 116. Likewise, second application 118 may request access to second health record 106 from second marshal 116 and access to third health record 108 and fourth health record 110 from third marshal 120. These requests may be mediated by the health-record server, which may further grant or deny access based on the responses provided by the first, second, and third marshals.

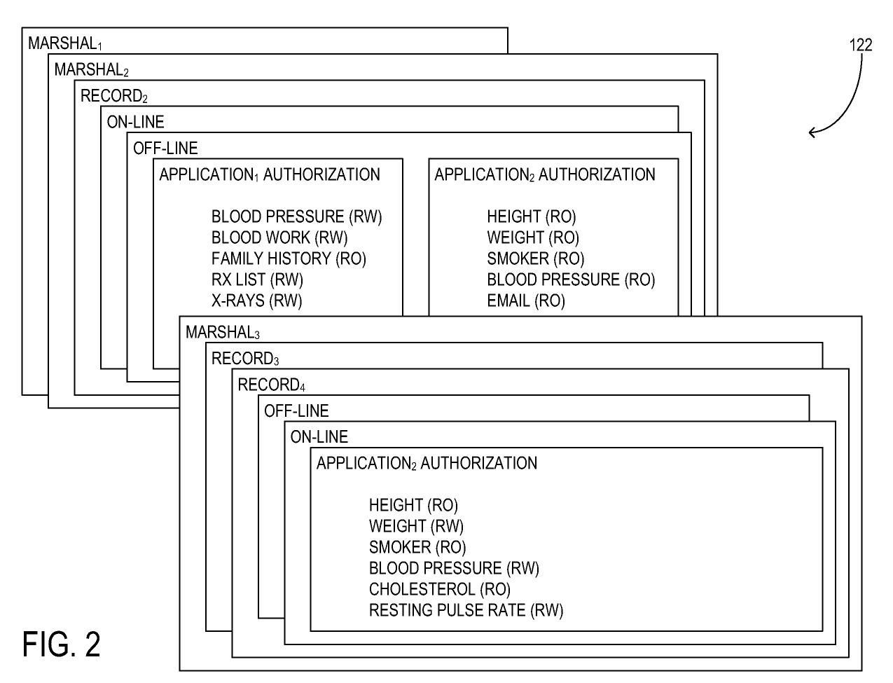

In some embodiments, health-record server 101 may be configured to regulate health-record access based on authorization catalog 122, a set of device-readable rules governing access to items in the served health records. The authorization catalog may be multidimensional: authorized access may be specific to each health record, to each item in the health record, to the access-seeking application, and to one or more conditions, e.g., whether the individual is logged into an application when access is requested. Further details are provided below, with an exemplary structure of the authorization catalog illustrated in FIG. 2.

FIG. 2 shows an exemplary structure of authorization catalog 122 in one exemplary instance, that instance corresponding to the embodiment illustrated in FIG. 1. Thus, continued reference is made to aspects of FIG. 1.

FIG. 2 shows authorization catalog 122 divided into a plurality of fields. A separate field is shown for each marshal having custody of one or more health records served by health-record server 101; fields corresponding to second marshal 116 and third marshal 120 are shown in detail.

In the illustrated embodiment, each marshal field is further divided into fields corresponding to the health records over which that marshal has custody. Thus, the field of the second marshal includes a field corresponding to the second health record; the field of the third marshal includes two fields: one corresponding to the third health record and the other to the fourth health record—the third marshal having custody over both the third and fourth health records.

In FIG. 2, each health-record field further divided into an on-line field and an off-line field. In this example, the on-line field includes rules governing access to the health record when a marshal of the health record is using or logged into the access-seeking application. The off-line field includes rules governing access to the health record when no marshal is using or logged into the access-seeking application.

In FIG. 2, the off-line field corresponding to the second health record and the on-line field corresponding to the fourth health record are shown in detail. Each of these fields is further divided into fields corresponding to each application to which some access to the health record has been authorized. In this example, the off-line field corresponding to the second health record includes a field corresponding to the first application and a field corresponding to the second application. The on-line field corresponding to the fourth health record includes one field only: a field corresponding to the second application.

Each application field in authorization catalog 122 lists the items within a specific health record that a specific application may have access to; it may further specify a level of access: read-write (RW) or read-only (RO) access, in this example. It should be understood that RW access may, in some embodiments, include an ability to create an item and/or to delete an item from a health record. In other embodiments, additional levels of access specified within authorization catalog 122 may authorize an application to create and/or delete an item.

It should be understood that numerous other variants of authorization catalog 122 are contemplated as well. Some authorization catalogs fully consistent with this disclosure may include less structure than the illustrated embodiment; others may include more structure. In one embodiment, the health-record server may be configured to maintain an historical record of access to each health record granted each application, in order to facilitate auditing or other scrutiny of health-record access.

Returning to FIG. 1, we find first request 124 associated with first application 112, and second request 126 associated with second application 118. Each of the first and second requests are requests made by an application for access to one or more items in an individual's health-record. The access requested in the request may enable the application to provide one or more services to the individual.

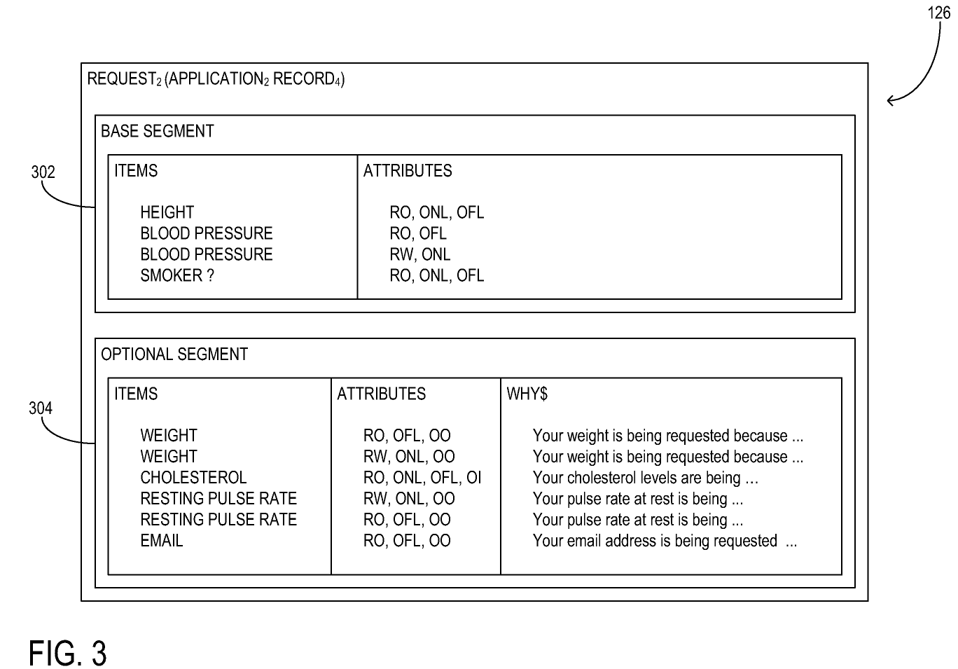

FIG. 3 shows second request 126 in exemplary detail. The second request lists one or more items in a health record to which access is requested and may further include one or more attributes associated with any of the one or more items. It should be understood that numerous specific request mechanisms are consistent with this disclosure, each one giving rise to a contemplated embodiment. Thus, in some embodiments, an application may request access to an item indirectly, by requesting a stored rule that specifies an item, access level, whether or not the application will provide service if access is denied, etc. Aspects of such stored rules are described herein below by example.

Some attributes may specify a requested level of access to an item in the health record. Thus, second request 126 includes an RO attribute associated with items for which read-only access is requested, and an RW attribute associated with items for which read-write access is requested.

Other attributes may specify a condition during or upon which access to the item is requested. Example conditions illustrated in FIG. 3 include an on-line (ONL) condition, where access is requested when a marshal of the health record is using or logged into the access-seeking application, and an off-line (OFL) condition, where access is requested when no marshal of the health record is using or logged into the access-seeking application.

Numerous other conditions are contemplated as well. They may include a condition where access to an item in a health record is requested when the individual to whom the health record belongs is actively receiving a service from a provider of the application, or is present at a facility associated with the application. Example conditions may further include one or more conditions where a time when the application seeks access to the item is within a predetermined range.

In the illustrated example, second request 126 is divided into two segments: base segment 302 and optional segment 304. In the base segment of the request, an application seeks the access it needs to provide a basic level of service to an individual. Therefore, the application may be configured to provide at least some service to the individual (i.e., to service the individual) if the access requested in the base segment is granted, and to refuse service to the individual if the access requested in the base segment is denied. In the optional segment of the request, an application seeks additional access to provide an extended level of service to the individual. Thus, in the illustrated example, the second application requires access to an individual's height, blood pressure, and smoking/non-smoking status in order to provide a basic level of service to that individual. To provide an extended level of service, the second application seeks access to the individual's weight, cholesterol levels, resting pulse rate, and email address, in addition to the access requested in the base segment.

The optional segment of a request may also include, for each item for which access is requested, an attribute that specifies a manner of requesting access to the item. Thus, in the illustrated example, optional segment 304 includes an opt-out (00) attribute associated with items for which access is anticipated by default, and which the marshal must actively opt out of to withhold access. Optional segment 304 further includes an opt-in (OI) attribute associated with items for which access is not anticipated by default, and which the marshal must actively opt into in order to authorize access.

The optional segment of a request may further include a why string for each item to which access is requested therein. The why string is an item-specific text string that indicates a reason why the application seeks access to the item. The why string may indicate potential advantages that could result from enabling access to the item. Thus, optional segment 304 includes a series of why strings associated with each item requested therein. Though not shown in the illustrated embodiment, additional why strings may be included for items to which access is requested in the base segment of the request. Why strings appearing in the base segment of the request may be substantially the same or at least partly different than those included in the optional segment of the request.

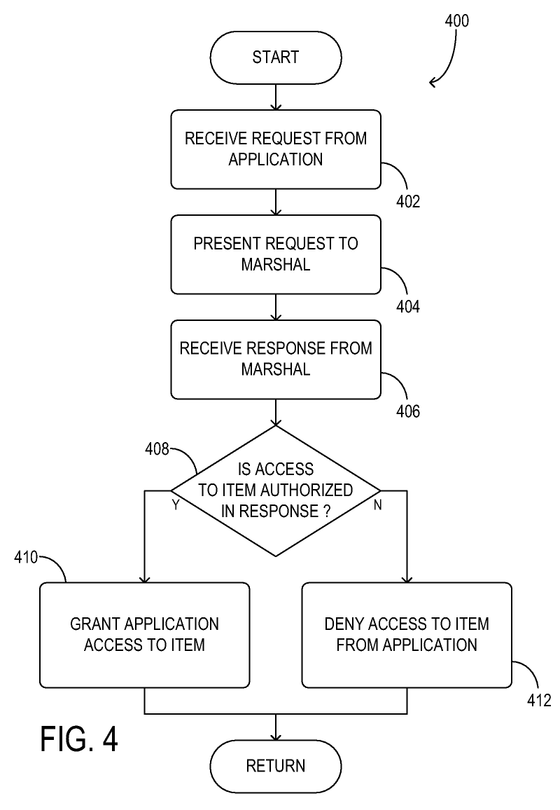

FIG. 4 shows an example method 400 to regulate access to a health record of an individual. The steps of method 400 may be executed by a health-record server configured as described above.

At 402, the health record server receives a request from an application, the request identifying an item in the health record to which access is requested and indicating whether the application is configured to service the individual if access is denied. As noted hereinabove, for items included in an optional segment of the request, the application may be configured to service the individual if access is denied, whereas for items included in a base segment, the application may be configured to refuse to service if access is denied. In some examples, the item may be one of a plurality of items in the health record to which access is requested via the request.

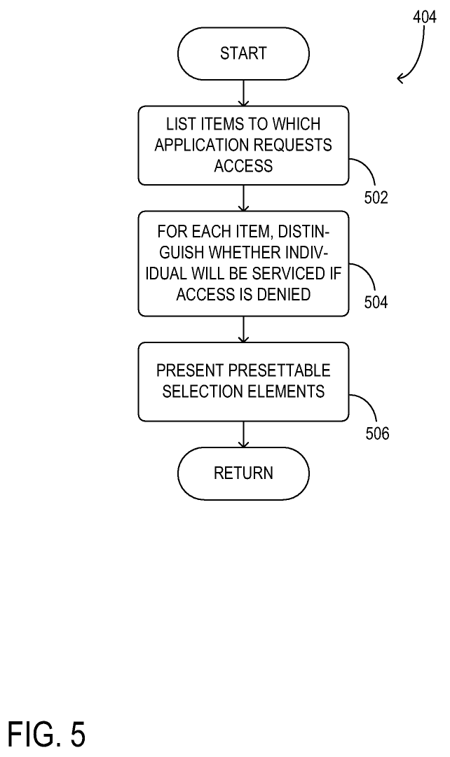

At 404, the health-record server presents the request to a marshal of the health record via a user interface. Aspects of the user interface are described below with reference to FIG. 5 and thereinafter.

At 406, the health-record server receives a response from the marshal of the health record via the user interface, the response indicating whether access to the item is authorized or withheld. In some embodiments, the response may distinguish a level of access to the item from among two or more different levels of access. For example, the two or more different levels of access may include a first level of access where reading the item and writing to the item are permitted, and a second level of access where reading the item is permitted but writing to the item is not permitted. In other examples, the two or more different levels of access may further include a third level of access where one or more of creating the item and deleting the item are permitted.

In some embodiments, the response may further indicate a condition for accessing the item. The condition may be one of a plurality of different conditions for accessing the item. For example, the plurality of different conditions may include a first condition where a marshal is using or logged into the access-seeking application when the application attempts to access the item, and wherein the application is granted access to the item if the first condition is satisfied. The plurality of different conditions may further include a first condition where the individual is using or logged into the access-seeking application or otherwise receiving a service from a provider of the application when the application attempts to access the item, and a second condition exclusive of the first condition, and wherein the application is granted access to the item if the first condition is satisfied. Finally, the plurality of different conditions may include a condition where a time when the application attempts to access the item is within a predetermined range, and wherein the application is granted access to the item if the first condition is satisfied.

At 408, the health-record server determines whether the response indicates that access to the item is authorized or whether it indicates that access to the item is withheld. If the response indicates that access to the item is authorized, then at 410, the health-record server updates an authorization catalog to grant the application access to the item. However, if the response indicates that access to the item is withheld, then at 412, the health-record server updates an authorization catalog to deny access to the item from the application.

FIG. 5 illustrates an example method 404 to present or mediate a request for access to items in a health record of an individual to a marshal of the health record via a user interface. The marshal may come to be presented with the request in a number of different ways, which depend on the configuration of the health-record server.

In one example scenario, an individual may be interacting with an application. The application may inform the individual that receiving a specified service, or any service at all, requires access to one or more items in the individual's health record. The application may then redirect the individual's client device (terminal, network browser, etc.) to a user interface of the health record server, where the individual, if a marshal of his or her own health record, would be able to authorize or withhold the access requested by the application. In other scenarios, a marshal of the health record may use a terminal, network browser, etc., to access the user interface of the health record server directly, e.g. by entering a network address (a URL, etc.) of the user interface. In this way, a marshal may determine, revise, or maintain access authorization to health records in his or her custody, whether in response to an application's query or absent any such query.

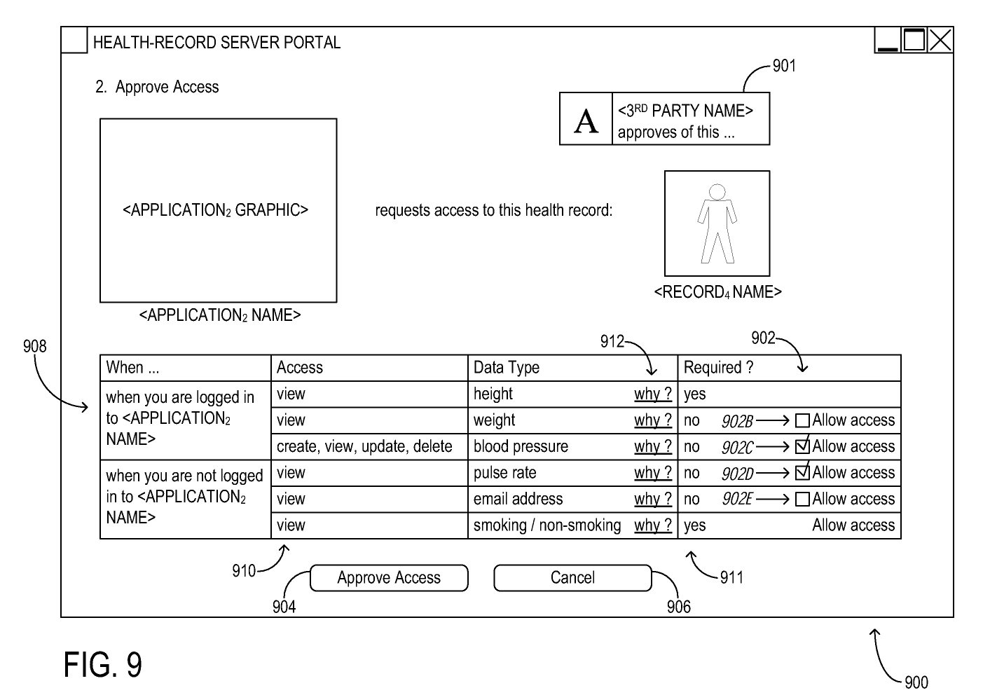

At 502, the health-record server lists one or more items in the health record, to which items an application has requested access. At 504, the health-record server distinguishes, for each of the one or more items, whether the application is configured to service the individual if access to that item is denied. At 506, the health-record server presents one or more presettable selection elements for each of the one or more items, the one or more presettable selection elements enabling a marshal of the health record to authorize or withhold access to that item. In some embodiments, the request may include an item to which the marshal may authorize access via an authorizing input sequence or withhold access via a withholding input sequence. In particular, the request may include an opt-out item, for which the authorizing input sequence is shorter than the withholding input sequence. In one example, where the user interface is a conventional graphical user interface, an authorizing input sequence shorter than a withholding input sequence may correspond to a case where M different mouse clicks are needed to authorize access, N different mouse clicks are needed to withhold access, and M<N. For example, with reference to FIG. 9, an “Allow access” checkbox may be checked by default, thus allowing a marshal to authorize access with one click at selection-confirming element 904. On the other hand, to deny access, the marshal first clicks to uncheck the “Allow access” checkbox and then uses a second click at selection-confirming element 904. The request may further include an opt-in item, for which the authorizing input sequence is longer than the withholding input sequence. In the present example, this may correspond to a case where N>M (e.g., the “Allow access” checkbox is unchecked by default).

The steps of method 404 may be executed by a health-record server configured as described above. Specifically, the memory of the health-record server may hold user-interface instructions that, when executed by the logic subsystem, send information via the communications subsystem for presenting the user interface as described above.

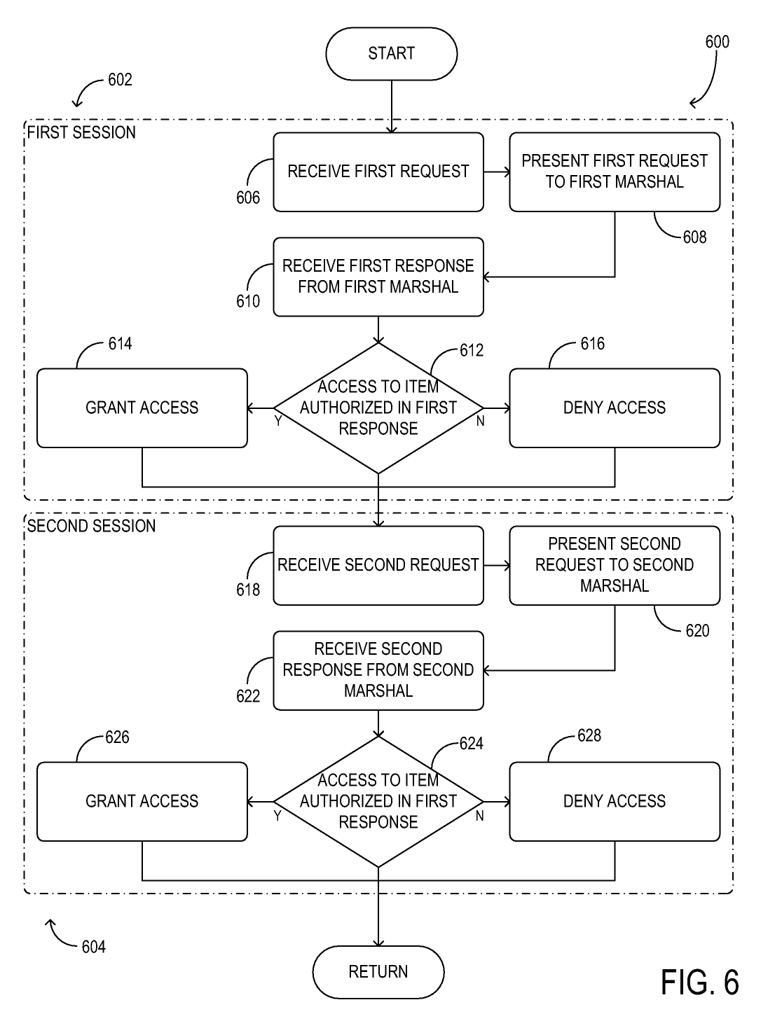

FIG. 6 shows an example method 600 for presenting a sequence of requests to one or more marshals of a health record for access to one or more items in the health record. The steps of method 600 may be executed by a health-record server as described above.

At 606, the health-record server receives a first request from an application to access one or more items in the health record. At 608, the health-record server presents the first request to a first marshal of the health record via a user interface. At 610, the health-record server receives a first response from the first marshal of the health record via the user interface, the first response indicating whether access to the one or more items is authorized or withheld. At 612, the health-record server determines whether the first response indicates that access to the one or more items is authorized or whether it indicates that access to the one or more items is withheld. If the first response indicates that access to the one or more items is authorized, then at 614, the health-record server updates an authorization catalog to grant the application access to the one or more items. However, if the first response indicates that access to the one or more items is withheld, then at 616, the health-record server updates an authorization catalog to deny access to the one or more items from the application. In some embodiments, steps 606-616 may be enacted in first session 602 of the user interface.

At 618, the health-record server receives a second request from the application to access subsequent one or more items of the health record. At 620, the health-record server presents the second request to a second marshal of the health record via a user interface. At 622, the health-record server receives a second response from the second marshal of the health record via the user interface, the second response indicating whether access to the subsequent one or more items is authorized or withheld. At 624, the health-record server determines whether the second response indicates that access to the subsequent one or more items is authorized or whether it indicates that access to the subsequent one or more items is withheld. If the second response indicates that access to the subsequent one or more items is authorized, then at 626, the health-record server updates an authorization catalog to grant the application access to the subsequent one or more items. However, if the second response indicates that access to the subsequent one or more items is withheld, then at 628, the health-record server updates an authorization catalog to deny access to the subsequent one or more items from the application. In some embodiments, steps 618-628 may be enacted in a second session 604 of the user interface, subsequent to first session 602.

It should be understood that in some embodiments, at least one of the one or more items to which access is requested in the first session may be included in the subsequent one or more items to which access is requested in the second session. Further, in some embodiments, the first response may authorize a first level of access, and the second response may authorize a second level of access different than the first level of access. It is further contemplated that in some embodiments, the first and second marshals may be the same. In embodiments and instances in which the first and second marshals are different, one or more authorization-reconciling mechanisms may be applied to reconcile conflicting access determinations made by first and second marshals. Thus, in some embodiments, different marshals of the same health record may be ranked in order of their right to modify an access authorization determined by another marshal.

In one, non-limiting example, the first request may include at least a base segment, and the second request may lack a base segment. Thus, the application is configured, when withheld access in the second response, to provide a first level of service to the individual, and when authorized access in the second response, to provide a second, greater level of service to the individual.

In other examples, the subsequent one or more items may include one of the one or more items to which access was withheld in the first response. Thus, some time after a marshal has withheld access to one or more items, the application can make a second request to the same marshal or to a different marshal, requesting access to at least one of the same items. Quality service provided by the application between the first and second requests may persuade a marshal to authorize access which he or she had previously withheld.

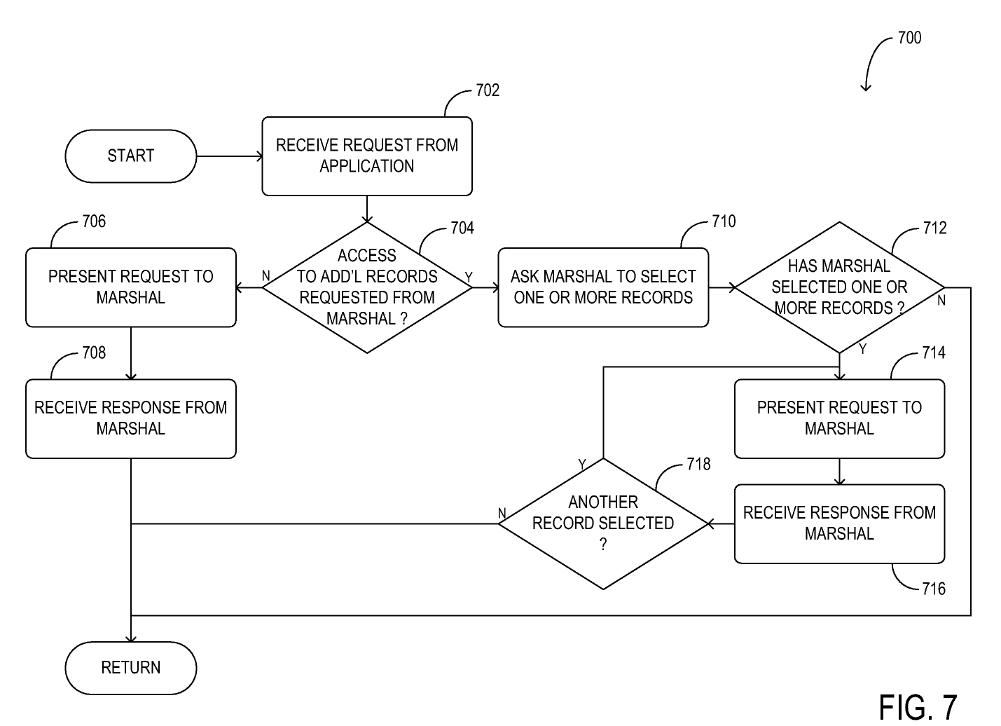

FIG. 7 shows an example method 700 to present or mediate a request for access to items in one or more health records to a marshal of the one or more health records via a user interface. The steps of method 700 may be executed by a health-record server as described above.

At 702, the health-record server receives a request from an application to access one or more items in a health record of an individual. The request may identify a marshal of the health record. At 704, the health-record server determines if the same application has requested access to items in other health records to which the same marshal may authorize or withhold access. Thus, the health record to which access is requested at 702 may be one of a plurality of health records in the marshal's custody that include an item to which access is requested via the request. If the application has not requested access to items in other health records in the marshal's custody, then at 706, the health-record server, via a user interface, presents to the marshal a request involving only one health record.

At 708, the health-record server receives a response from the marshal via the user interface, the response indicating whether access to the one or more items is authorized or withheld. However, if the application has requested access to items in other health records in the marshal's custody, then at 710, in a first presentation of the user interface, the marshal is asked to select one or more health records to which access may be determined (i.e., authorized or withheld) in a second, subsequent presentation of the user interface. Thus, method 700 may include enabling the marshal, in a first presentation of the user interface, to select the health record from among two or more health records to which the application has requested access.

At 712, the health-record server determines whether the marshal has agreed to determine access to one or more health records in his or her custody. If the marshal refuse to determine access, then the first presentation closes and method 700 returns. But if the marshal agrees to determine access to at least one health record, then at 714, the first presentation closes, and, in a second presentation, the health-record server presents a request to the marshal. Thus, method 700 enables the marshal to authorize or withhold access to each of the one or more items in a second presentation of the user interface, subsequent to the first presentation. Because the health record is selected in the first presentation and authorized in a second, subsequent presentation, the one or more presettable selection elements allow the marshal to authorize unequal access to corresponding items in the two or more health records.

At 716, the health-record server receives a response to the request and updates an authorization catalog to reflect the response. At 718, the health-record server determines if another health record which the marshal has elected to authorize remains to be authorized. If so, the method returns to 714. Otherwise, at 720, method 700 returns.

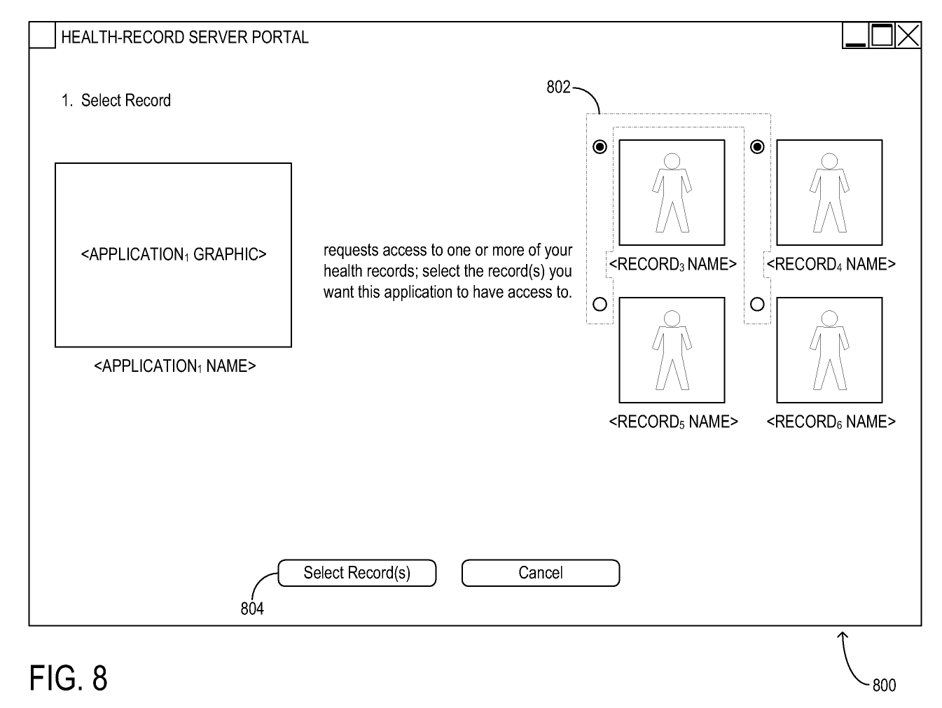

FIGS. 8 and 9 illustrate user-interface presentations consistent with example methods 400, 500, 600, and 700. In some embodiments, the user interface includes two presentations presented sequentially: first presentation 800, shown by example in FIG. 8, and subsequent, second presentation 900, shown by example in FIG. 9.

Consistent with method 700, first presentation 800 is configured to enable a marshal to select one or more health records to which access may be determined. For each of the selected health records, access may be determined in subsequent, second presentation 900. The first presentation is configured to enable the marshal to select one or more health records from among two or more health records within which an application has requested access. In the illustrated example, the first presentation comprises various graphical user-interface elements, which include selection elements 802 and first selection-confirming element 804. In this example, the marshal may select the one or more health records by actuating the appropriate selection elements followed by the first selection-confirming element.

It should be understood that in some embodiments fully consistent with this disclosure, health-record selecting may be subsumed into a subsequent access-determining presentation of the user interface, or omitted entirely. Further, in situations where an application requests access to only one health record in a marshal's custody, first presentation 800 and its associated functionality may be omitted.

Second presentation 900 is presented after the first presentation and is configured to enable the marshal to authorize or withhold access to each of one or more items in the health record to which access is requested. In the illustrated example, the second presentation includes approval-reciting element 901 configured to display a third-party statement of approval of the application or of a provider of the application. Such an approval-reciting element may take the form of a seal or certification from a trusted entity, thus facilitating a trust-decision by a marshal. The second presentation also includes presettable selection elements 902 (viz. 902B through 902E, also referred to as “Allow access” checkboxes), second selection-confirming element 904, and selection-resetting element 906. In this example, the marshal may toggle between authorizing access to an item and withholding access to the same item by actuating the presettable selection element corresponding to the item. If the marshal then actuate the selection-resetting element, then any changes to the authorization catalog that he or she may have indicated are abandoned. But, if the marshal actuate the second selection-confirming element instead of the selection-resetting element, then the indicated changes are updated in the authorization catalog.

In the illustrated embodiment of FIG. 9, each of the one or more items to which access is requested is represented in table 908. Table 908 includes a row corresponding to each of the one or more items to which access is requested; each row includes one or more presettable selection elements 902 configured to enable the marshal to modify an authorized level of access to that item, a level indicating element 910 identifying a requested level of access to that item (e.g., read only, read and write, etc.), and a configuration-indicating element 911 indicating whether the application is configured to service the individual when access to that item is denied. The configuration-indicating element may, in some examples, indicate that access is required for items to which access was requested in a base segment of an application's request (FIG. 3, q.v.). Conversely, the configuration-indicating element may indicate that access is optional for items to which access was requested in an optional segment of the application's request.

In the illustrated embodiment, second presentation 900 includes one or more opt-out items with corresponding presettable selection elements (902C and 902D) preset to authorize access to the opt-out item when second selection-confirming element 904 is triggered, and wherein an input received via the presettable selection element causes access to the opt-out item to be withheld when the second selection-confirming element is triggered. Second presentation 900 also includes one or more opt-in items with corresponding presettable selection elements (902B and 902E) preset to withhold access to the opt-in items when second selection-confirming element 904 is triggered, and wherein an input received via the presettable selection element causes access to the opt-in item to be authorized when the second selection-confirming element is triggered.

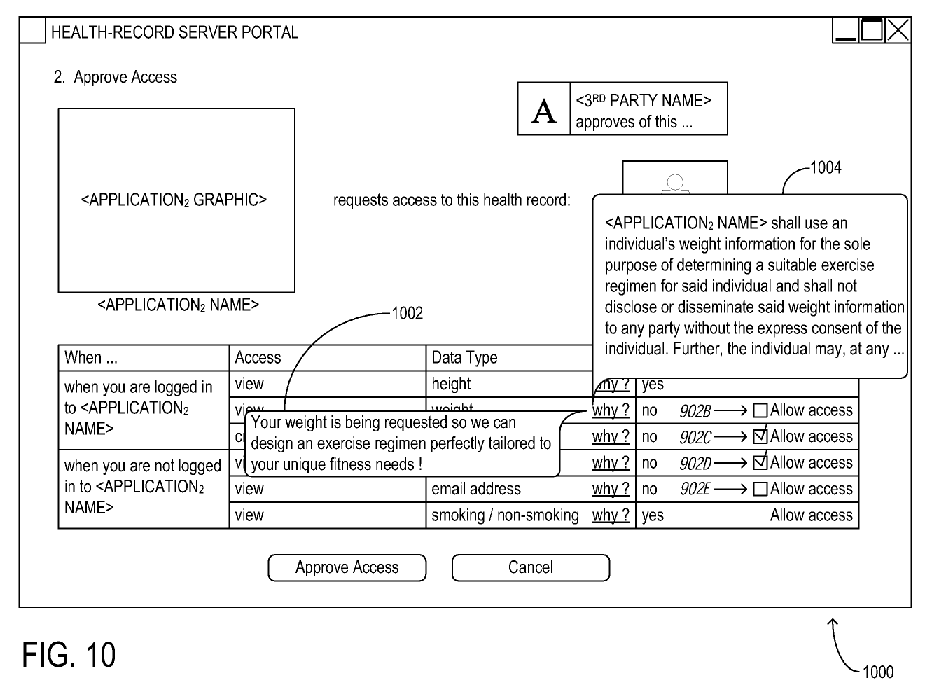

Table 908 further includes, coordinate to each of the one or more items, a reason-indicating element 912 configured to present an item-specific explanation indicating why access to that item is requested. In some embodiments, the reason-indicating element may include a hyperlink to an item-specific explanation. Such item-specific explanation may take the form of a text string, an audio-including explanation, a video-including explanation, an explanatory graphic, or another suitable explanation. In some embodiments, the item-specific explanation presented by the reason-indicating element may include the item-specific why string provided in the application's request for access. The item-specific explanation may further include educational or guidance information to inform the marshal of various aspects of the access determination, e.g., a trust-descision aspect. In other embodiments, the reason-indicating element may be further configured to display some or all of a license agreement governing the application's use or dissemination of the requested item. In still other embodiments, a policy-reciting interface element, distinct from but linked to the reason-indicating element, may display some or all of the license agreement. An example is shown in FIG. 10. It is further contemplated that a provider of the application may, in some embodiments, be contractually enjoined from using access to the item for reasons other than those recited in the item-specific explanation.

FIG. 10 shows another instance of second presentation 900, wherein a marshal has selected (in some examples, clicked on) a reason-indicating element of the presentation. The reason-indicating element is shown displaying item-specific explanation 1002 and presenting policy-reciting interface element 1004. FIG. 10 illustrates one of several contemplated examples in which a policy-reciting element appears before or above the one or more presettable selection elements so that the marshal is made fully aware of relevant policies prior to determining access.

It should be understood that FIGS. 8 and 9 describe a user interface in only one example embodiment, and that numerous other embodiments are contemplated. For example, the user interface may be configured to identify one or more items in the health record to which access is required in order for the application to provide a specified service to the individual.

It should further be understood that the configurations and/or approaches described herein are exemplary in nature, and that these specific embodiments or examples are not to be considered in a limiting sense, because numerous variations are contemplated. Accordingly, the subject matter of the present disclosure includes all novel and non-obvious combinations and sub-combinations of the configurations and approaches disclosed herein, as well as any and all equivalents thereof.

1. A method to regulate access to a health record of an individual, the method comprising:
receiving a request from an application, the request identifying an item in the health record to which access is requested and indicating whether the application is configured to service the individual if access is denied;
presenting the request to a marshal of the health record via a user interface;
receiving a response from the marshal of the health record via the user interface, the response indicating whether access to the item is authorized or withheld;
granting the application access to the item if the response indicates that access to the item is authorized; and
denying access to the item from the application if the response indicates that access to the item is withheld.

2. The method of claim 1, wherein the response distinguishes a level of access to the item from among two or more different levels of access.

3. The method of claim 2, wherein the two or more different levels of access include a first level of access where reading the item and writing to the item are permitted, and a second level of access where reading the item is permitted but writing to the item is not permitted.

4. The method of claim 3, wherein the two or more different levels of access further include a third level of access where one or more of creating the item and deleting the item are permitted.

5. The method of claim 1, wherein the item is one of a plurality of items in the health record to which access is requested via the request.

6. The method of claim 1, wherein the request further includes an item-specific text string indicating a reason why the application is requesting access to the item.

7. The method of claim 1, wherein the marshal authorizes access via an authorizing input sequence and withholds access via a withholding input sequence, and the authorizing input sequence is longer than the withholding input sequence.

8. The method of claim 1, wherein the marshal authorizes access via an authorizing input sequence and withholds access via a withholding input sequence, and the authorizing input sequence is shorter than the withholding input sequence.

9. The method of claim 1, further comprising maintaining an historical record of access granted the application.

10. A method to regulate access to a health record of an individual, the method comprising:
receiving a request from an application, the request identifying an item in the health record to which access is requested;
presenting the request to a marshal of the health record via a user interface;
receiving a response from the marshal via the user interface, the response indicating whether access to the item is authorized or withheld, and further indicating a condition for accessing the item;
granting the application access to the item subject to the condition if the response indicates that access to the item is authorized; and
denying access to the item from the application if the response indicates that access to the item is withheld.

11. The method of claim 10, wherein the condition is one of a plurality of different conditions for accessing the item.

12. The method of claim 11, wherein the plurality of different conditions includes a first condition where the marshal is using or logged into the application when the application attempts to access the item, and wherein the application is granted access to the item if the first condition is satisfied.

13. The method of claim 11, wherein the plurality of different conditions includes a first condition where the individual is receiving a service from a provider of the application when the application attempts to access the item, and wherein the application is granted access to the item if the first condition is satisfied.

14. The method of claim 11, wherein the plurality of different conditions includes a first condition where a time when the application attempts to access the item is within a predetermined range, and wherein the application is granted access to the item if the first condition is satisfied.

15. A method of incrementally querying one or more marshals of a health record for access to one or more items in the health record, the method comprising:
in a first session, receiving a first request from an application to access one or more items in the health record;
presenting the first request to a first marshal of the health record via a user interface;
receiving a first response from the first marshal of the health record via the user interface, the first response indicating whether access to the one or more items is authorized or withheld;
if the first response indicates that access to the one or more items is withheld, then denying access to the one or more items; and
if the first response indicates that access to the one or more items is authorized, then granting the application access to the one or more items;
in a second session, after the first session, receiving a second request from the application to access subsequent one or more items of the health record;
presenting the second request to a second marshal of the health record via a user interface;
receiving a second response from the second marshal of the health record via the user interface, the second response indicating whether access to the subsequent one or more items is authorized or withheld;
granting the application access to the subsequent one or more items if the second response indicates that access to the subsequent one or more items is authorized; and
denying access to the subsequent one or more items if the second response indicates that access to the subsequent one or more items is withheld.

16. The method of claim 15, wherein at least one of the one or more items to which access is requested in the first session is included in the subsequent one or more items to which access is requested in the second session.

17. The method of claim 16, wherein the first response authorizes a first level of access, and the second response authorizes a second level of access different than the first level of access.

18. The method of claim 17, wherein the first and second marshals are the same.

19. The method of claim 15, wherein the application is configured, when withheld access in the second response, to provide a first level of service to the individual, and when authorized access in the second response, to provide a second, greater level of service to the individual.

20. The method of claim 15, wherein the subsequent one or more items includes at least one of the one or more items to which access is withheld in the first response.
